(19) United States
(12) Patent Application Publication
(10) Pub. No.: US 2025/0208599 A1
(43) Pub. Date: Jun. 26, 2025

(54) METHODS AND SYSTEMS FOR ASSESSING PRODUCT QUALITY BASED ON INDUSTRIAL INTERNET OF THINGS

(71) Applicant: CHENGDU QINCHUAN IOT TECHNOLOGY CO., LTD., Chengdu (CN)

(72) Inventor: Hanshu SHAO, Chengdu (CN)

(73) Assignee: CHENGDU QINCHUAN IOT TECHNOLOGY CO., LTD., Chengdu (CN)

(21) Appl. No.: 19/074,508

(22) Filed: Mar. 10, 2025

(30) Foreign Application Priority Data
Dec. 23, 2024 (CN) 202411898699.8

(51) Int. Cl. G05B 19/406; G06F 16/23

(52) U.S. Cl. CPC G05B 19/406; G05B 2219/32194; G06F 16/23

(57) ABSTRACT

Provided are a method and a system for assessing product quality based on IIoT. The method comprises: obtaining one or more segments of a current production line; for each segment of the one or more segments: determining, based on a segment characteristic of the segment, a first abnormality degree and a segment criticality degree of the segment; determining a segment monitoring level based on the segment criticality degree and the first abnormality degree; determining a quality inspection parameter based on the segment monitoring level and issuing the quality inspection parameter to a quality inspection device; obtaining a product quality characteristic of the segment by controlling the quality inspection device to perform quality inspection on a product of the segment based on the quality inspection parameter; and updating the quality database by generating quality update data based on the segment characteristic and the product quality characteristic.

### CROSS-REFERENCE TO RELATED APPLICATIONS

This application claims priority to Chinese Patent Application No. 202411898699.8, filed on Dec. 23, 2024, the entire contents of which are hereby incorporated by reference.

### TECHNICAL FIELD

The present disclosure relates to the field of product quality assessment, and in particular, to a method and a system for assessing product quality based on Industrial Internet of Things (IIoT).

### BACKGROUND

In today's highly automated industrial production environments, common general-purpose production lines are often comprised of multiple, tightly interconnected segments, each of which is directly related to the quality and performance of the final product. Traditional quality monitoring methods often rely on manual inspection, which is time-consuming and prone to human error. In contrast, the Industrial Internet of Things (IIoT) technology, through the integration of sensors, smart devices, and data analytics systems, can monitor parameters in the production process in real-time, thus realizing a comprehensive assessment of product quality.

Therefore, it is desirable to provide a method and a system for assessing product quality based on IIoT, which helps to collect and analyze various data in the production process accurately in real-time, thereby optimizing the production process and improving production efficiency.

### SUMMARY

One aspect of embodiments of the present disclosure provides a method for assessing product quality based on Industrial Internet of Things (IIoT). The method is executed by an IIoT management platform. The method comprises: obtaining one or more segments of a current production line based on an IIoT perceptual control platform. The method further comprises: for each segment of the one or more segments: determining, based on a segment characteristic of the segment, a first abnormality degree and a segment criticality degree of the segment through a quality database; determining a segment monitoring level based on the segment criticality degree and the first abnormality degree; determining a quality inspection parameter based on the segment monitoring level and issuing the quality inspection parameter to a quality inspection device of the IIoT perceptual control platform; obtaining a product quality characteristic of the segment by controlling the quality inspection device to perform a quality inspection on a product of the segment based on the quality inspection parameter; and updating the quality database by generating quality update data based on the segment characteristic and the product quality characteristic.

Another aspect of embodiments of the present disclosure provides a system for assessing product quality based on Industrial Internet of Things (IIoT). The system comprises an IIoT user platform, an IIoT service platform, an IIoT management platform, an IIoT sensor network platform, and an IIoT perceptual control platform. The IIoT management platform is configured to obtain one or more segments of a current production line based on the IIoT perceptual control platform. The IIoT management platform is further configured to: for each segment of the one or more segments: determine, based on a segment characteristic of the segment, a first abnormality degree and a segment criticality degree of the segment through a quality database; determine a segment monitoring level based on the segment criticality degree and the first abnormality degree; determine a quality inspection parameter based on the segment monitoring level and issue the quality inspection parameter to a quality inspection device of the IIoT perceptual control platform; obtain a product quality characteristic of the segment by controlling the quality inspection device to perform a quality inspection on a product of the segment based on the quality inspection parameter; and update the quality database by generating quality update data based on the segment characteristic and the product quality characteristic.

Another aspect of embodiments of the present disclosure provides a non-transitory computer-readable storage medium for storing computer instructions. When reading the computer instructions in the storage medium, a computer implements the method for assessing product quality based on Industrial Internet of Things (IIoT) described in some embodiments of the present disclosure.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering denotes the same structure, wherein:

FIG. 1 is a block diagram illustrating exemplary platforms of a system for assessing product quality based on Industrial Internet of Things (IIoT) according to some embodiments of the present disclosure;

FIG. 2 is a flowchart illustrating an exemplary process for assessing product quality based on IIoT according to some embodiments of the present disclosure;

FIG. 3 is an exemplary schematic diagram illustrating the determination of a first abnormality degree and a segment criticality degree according to some embodiments of the present disclosure; and

FIG. 4 is an exemplary schematic diagram illustrating the determination of a quality inspection parameter according to some embodiments of the present disclosure.

### DETAILED DESCRIPTION

To more clearly illustrate the technical solutions of the embodiments of the present disclosure, the accompanying drawings to be used in the description of the embodiments will be briefly described below. Obviously, the accompanying drawings in the following description are only some examples or embodiments of the present disclosure, and that the present disclosure may be applied to other similar scenarios in accordance with these drawings without creative labor for those of ordinary skill in the art. Unless obviously acquired from the context or the context illustrates otherwise, the same numeral in the drawings refers to the same structure or operation.

It should be understood that “system,” “device,” “unit,” and/or “module” as used herein is a way to distinguish between different components, elements, parts, sections, or assemblies at different levels. However, these words may be replaced by other expressions if they accomplish the same purpose.

As indicated in the present disclosure and in the claims, the singular forms “a,” “an,” and “the” may be intended to include the plural forms as well, unless the context clearly indicates otherwise. In general, the terms “comprise,” “comprises,” and/or “comprising,” “include,” “includes,” and/or “including,” when used in this disclosure, specify the presence of stated features, integers, steps, operations, elements, and/or components, but do not preclude the presence or addition of one or more other features, integers, steps, operations, elements, components, and/or groups thereof.

Flowcharts are used in the present disclosure to illustrate the operations performed by the system according to some embodiments of the present disclosure. It should be understood that the operations described herein are not necessarily executed in a specific order. Instead, they may be executed in reverse order or simultaneously. Additionally, one or more other operations may be added to these processes, or one or more operations may be removed.

In the modern manufacturing industry, complex and efficient production lines are usually tightly interconnected by multiple segments, each of which affects the quality of the final product. To ensure the stability and consistency of product quality, comprehensive quality monitoring of the production line becomes especially critical. In view of the above, some embodiments of the present disclosure provide a method and a system for assessing product quality based on Industrial Internet of Things (IIoT), which realize real-time data acquisition and product quality assessment across various aspects of the production line through the integration of sensors, devices, and network communication technology to improve the overall production efficiency and quality level of an enterprise.

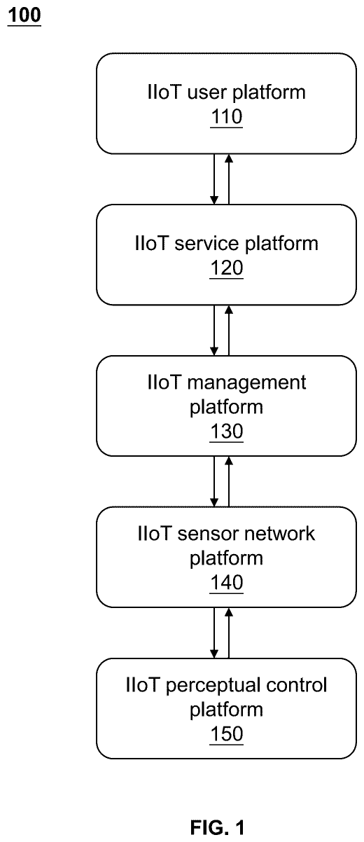

FIG. 1 is a block diagram illustrating exemplary platforms of a system for assessing product quality based on Industrial Internet of Things (IIoT) according to some embodiments of the present disclosure.

As shown in FIG. 1, a system 100 for assessing product quality based on IIoT (hereinafter referred to as the system 100) may include an IIoT user platform 110, an IIoT service platform 120, an IIoT management platform 130, an IIoT sensor network platform 140, and an IIoT perceptual control platform 150.

The IIoT user platform 110 is a platform configured to enable interactions between a user and the system 100.

In some embodiments, the IIoT user platform 110 may be configured as a user terminal. The user terminal refers to one or more terminal devices used by the user. The user refers to a person in charge of the system 100, etc. For example, the user terminal may include a cell phone, a tablet, a client, a web page, or the like.

The IIoT service platform 120 is a platform for service communication and for processing and storing service data.

In some embodiments of the present disclosure, the IIoT service platform 120 may be configured as a single server or as a group of servers. The group of servers may be centralized or distributed, for example, the group of servers may form a distributed system. In some embodiments of the present disclosure, the servers may be local or remote.

In some embodiments of the present disclosure, the IIoT service platform 120 may also be configured to include a database or a storage device.

In some embodiments of the present disclosure, the IIoT service platform 120 may interact with the IIoT user platform 110 and the IIoT management platform 130 for data exchange.

The IIoT management Platform 130 is a platform configured within factories for performing IIoT management.

In some embodiments of the present disclosure, the IIoT management platform 130 may be configured as a processor, such as a central processor, a microcontroller, an embedded processor (EP), a graphics processor (GPU), etc., or any combination of the above.

In some embodiments of the present disclosure, the IIoT management platform 130 may interact with the IIoT service platform 120 and the IIoT sensor network platform 140 for data exchange.

The IIoT sensor network platform 140 refers to a sensory communication platform that facilitates the uploading of perceptual information and the dissemination of control information. For example, the IIoT sensor network platform 140 may be configured as a gateway, a data interface, or the like.

The IIoT perceptual control platform 150 is a functional platform for obtaining sensing information and controlling the execution of commands. In some embodiments of the present disclosure, the IIoT perceptual control platform 150 may be configured in a factory production line, a factory storage and logistics center, a factory equipment monitoring room, or the like. In some embodiments of the present disclosure, the IIoT perceptual control platform 150 may include an operational device, a quality inspection device, a monitoring device, or the like. The operational device refers to a device used for manufacturing, which may include a machine tool, a robotic arm, or the like. The quality inspection device refers to a device used for quality testing, which may include a laser range finder, a mechanics tester, an image inspection device, or the like. The monitoring device refers to a device used to obtain an operation status and a production status of the operational device, which may include a sensor, a Programmable Logic Controller (PLC) system, or the like.

In some embodiments of the present disclosure, the IIoT sensor network platform 140 may interact with the IIoT management platform 130 and the IIoT perceptual control platform 150 for data exchange.

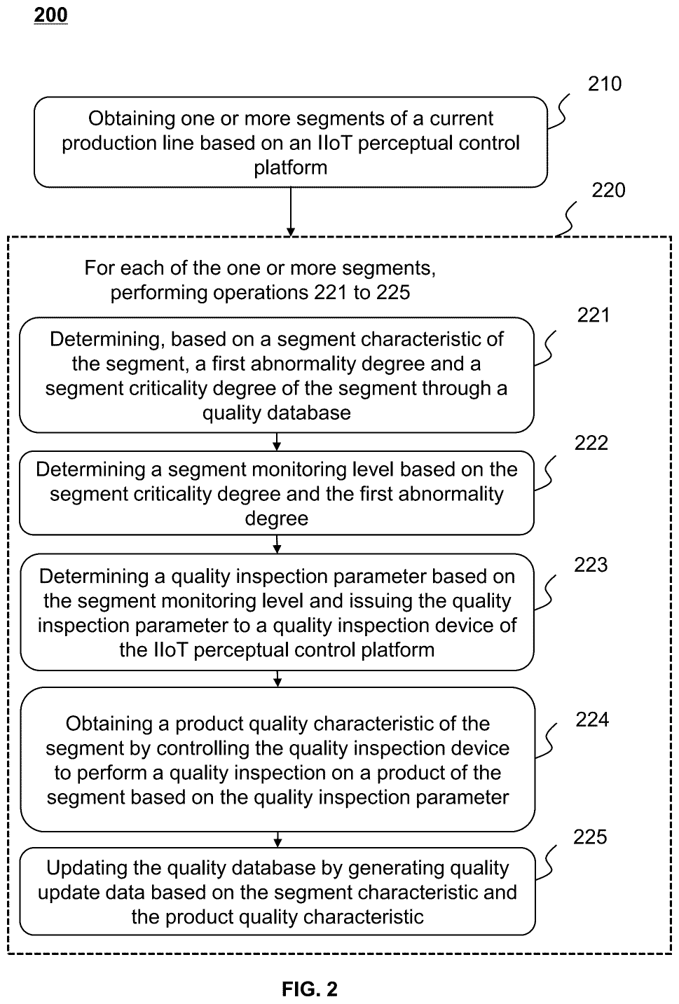

In some embodiments of the present disclosure, the IIoT management platform 130 may be configured to obtain one or more segments of a current production line based on the IIoT perceptual control platform 150. For each segment of the one or more segments, the IIoT management platform 130 may be configured to: determine, based on a segment characteristic of the segment, a first abnormality degree and a segment criticality degree of the segment through a quality database; determine a segment monitoring level based on the segment criticality degree and the first abnormality degree; and determine a quality inspection parameter based on the segment monitoring level and issue the quality inspection parameter to the quality inspection device of the IIoT perceptual control platform 150. The IIoT management platform 130 may be further configured to: obtain a product quality characteristic of the segment by controlling the quality inspection device to perform quality inspection on a product of the segment based on the quality inspection parameter; and update the quality database by generating quality update data based on the segment characteristic and the product quality characteristic. For more information about this section, please refer to FIG. 2 through FIG. 4 and their related descriptions.

It should be noted that the above description of the system for assessing product quality based on IIoT is provided only for descriptive convenience, and does not limit the present disclosure to the scope of the cited embodiments. It may be understood that for a person skilled in the art, with an understanding of the principle of the system, it may be possible to arbitrarily combine various platforms or constitute subsystems to be connected to other platforms without departing from the principle.

FIG. 2 is a flowchart illustrating an exemplary process for assessing product quality based on IIoT according to some embodiments of the present disclosure. As shown in FIG. 2, process 200 includes the following operations. In some embodiments of the present disclosure, process 200 may be performed by an IIoT management platform.

In some embodiments of the present disclosure, the IIoT management platform may be configured to obtain one or more segments of a current production line based on an IIoT perceptual control platform. For each segment of the one or more segments, the IIoT management platform may be configured to: determine, based on a segment characteristic of the segment, a first abnormality degree and a segment criticality degree of the segment through a quality database; determine a segment monitoring level based on the segment criticality degree and the first abnormality degree; and determine a quality inspection parameter based on the segment monitoring level and issue the quality inspection parameter to the quality inspection device of the IIoT perceptual control platform. The IIoT management platform may be further configured to: obtain a product quality characteristic of the segment by controlling the quality inspection device to perform quality inspection on a product of the segment based on the quality inspection parameter; and update the quality database by generating quality update data based on the segment characteristic and the product quality characteristic.

In 210, obtaining one or more segments of a current production line based on an IIoT perceptual control platform.

The current production line refers to a production line whose quality is currently required to be assessed.

The one or more segments refer to processing steps in the production line that follow a certain sequence or are interrelated.

In some embodiments of the present disclosure, the IIoT management platform may obtain one or more segments of the current production line through an IIoT sensor network platform based on the IIoT perceptual control platform. More descriptions of the IIoT management platform, the IIoT perceptual control platform and the IIoT perceptual control platform may be found in FIG. 1 and the related descriptions thereof.

In 220, for each of the one or more segments, operations 221 to 225 may be performed.

When the following operations are performed for each of the one or more segments, the current segment is designated as a target segment, and each of the one or more segments is designated as the target segment sequentially.

In 221, determining, based on a segment characteristic of the segment, a first abnormality degree and a segment criticality degree of the segment through a quality database.

The segment characteristic refers to a machining characteristic of the segment. In some embodiments, the segment characteristic may include a part characteristic, an assembly characteristic, an equipment characteristic, or the like. The part characteristic may include a part name, a part size, a machining accuracy, or the like. The assembly characteristic may include an assembly sequence, an assembly process, an assembly accuracy, or the like. The equipment characteristic may include a device used, or the like. The higher the value of the machining accuracy is, the higher an accuracy requirement is for a machining process. The higher the value of the assembly accuracy is, the higher an accuracy requirement is for an assembly process.

In some embodiments, the IIoT management platform may obtain the segment characteristic of the target segment by reading drawings (e.g., parts drawings, assembly drawings, or process documents), or obtain the segment characteristic input by a user through an IIoT user platform.

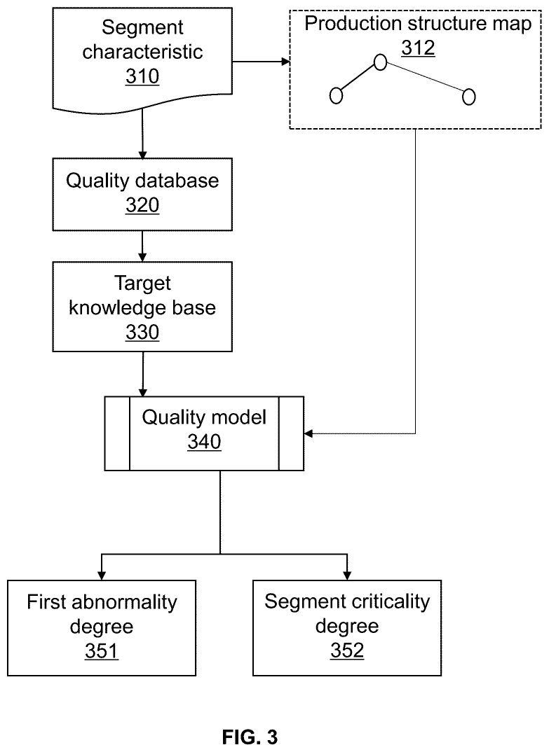

More descriptions of the IIoT user platform may be found in FIG. 1 and the related descriptions thereof. Further descriptions of the part characteristic and the assembly characteristic may be found in FIG. 3 and the related descriptions thereof.

The quality database refers to a database that contains data related to a plurality of segments of a historical production line. In some embodiments, the quality database may include field names and their corresponding data, such as a segment ID for each segment of the historical production line, a historical segment characteristic of the segment, a historical segment characteristic of a previous segment, a historical segment characteristic of a subsequent segment, a historical quality characteristic, or the like.

The segment ID of a segment refers to an identifier of the segment. In some embodiments, each of a plurality of segments of a plurality of production lines has a corresponding segment ID. The historical quality characteristic of a segment may include a count of products corresponding to the segment in historical data, a count of abnormal products corresponding to the segment in the historical data, or the like. The count of abnormal products may be a sum of a count of substandard products and a count of non-conforming products. The substandard products refer to products of a relatively poor quality but may still proceed to the subsequent segment for further production, while the non-conforming products refer to products that cannot proceed to the subsequent segment and are directly discarded.

In some embodiments, the IIoT management platform may construct the quality database based on historical data. For example, the IIoT management platform may retrieve the historical data based on segment IDs, determine the segment corresponding to each of the segment IDs, as well as historical segment characteristics, historical quality characteristics, etc. of a previous segment and a subsequent segment. When multiple pieces of historical data are retrieved for a same segment ID, an average value of the multiple pieces of historical data may be determined, and the quality database is constructed based on the segment corresponding to each of the segment IDs, as well as the historical segment characteristics, the historical quality characteristics, etc. of the previous segment and the subsequent segment. Each segment ID and its corresponding historical data corresponds to a row in the quality database.

For more descriptions of the quality database, please refer to FIG. 3 and the related descriptions thereof.

The first abnormality degree is an indicator of a degree of abnormality in an output of a segment.

The segment criticality degree is an indicator of how critical a segment is to a finished product.

In some embodiments, the IIoT management platform may determine the first abnormality degree and the segment criticality degree for the target segment based on the segment characteristic of the target segment, the segment characteristic of the previous segment, and the segment characteristic of the subsequent segment, via the quality database. For example, the IIoT management platform may construct a first feature vector based on the segment characteristic of the target segment and the previous and subsequent segments. By matching with the quality database, a first reference vector with a highest similarity is selected as a first target vector. Based on the historical segment characteristic and the historical quality characteristic of the segment corresponding to the first target vector, the first abnormality degree and the segment criticality degree of the target segment are obtained respectively through a corresponding calculation manner.

By way of example, the first abnormality degree may be determined by a percentage of the count of abnormal products in the historical quality characteristic corresponding to the first target vector. The segment criticality degree may be calculated as a result of a weighted average of the machining accuracy and the assembly accuracy of the segment characteristic of the target segment, multiplied by a quality coefficient. A weight for the weighted average may be set by a technician based on historical data and prior knowledge, and the quality coefficient may be positively correlated to the count of abnormal products in the historical quality characteristic corresponding to the first target vector.

A first reference vector is a vector generated based on the quality database. For example, the historical segment characteristics of the segment corresponding to each segment ID in the quality database and the historical segment characteristics of a previous segment and a subsequent segment of the segment corresponding to each segment ID in the quality database may be taken as first reference vectors. The historical quality characteristic corresponding to the first reference vector may be taken as a label corresponding to the first reference vector. The similarity may be determined based on a cosine distance, a Euclidean distance, etc.

It may be understood that when constructing the first reference vector and the first feature vector, the IIoT management platform may set the (historical) segment characteristic of the previous segment to a null value when the corresponding segment is a first segment of the production line, and the IIoT management platform may set the (historical) segment characteristic of the subsequent segment to a null value when the segment is a final segment of the production line.

In 222, determining a segment monitoring level based on the segment criticality degree and the first abnormality degree.

The segment monitoring level is data that characterizes an intensity of monitoring of a segment.

In some embodiments, the IIoT management platform may determine the segment monitoring level based on the segment criticality degree and the first abnormality degree in multiple ways. For example, the segment monitoring level may be positively correlated to the segment criticality degree and the first abnormality degree. By way of example, the IIoT management platform may determine a weighted average of the segment criticality degree and the first abnormality degree, and determine the segment monitoring level based on a numerical range in which a result of the weighted average falls. A weight for the weighted average, as well as a correspondence between different numerical ranges and segment monitoring levels, may be set by a technician based on historical data and prior knowledge.

In 223, determining a quality inspection parameter based on the segment monitoring level and issuing the quality inspection parameter to a quality inspection device of the IIoT perceptual control platform.

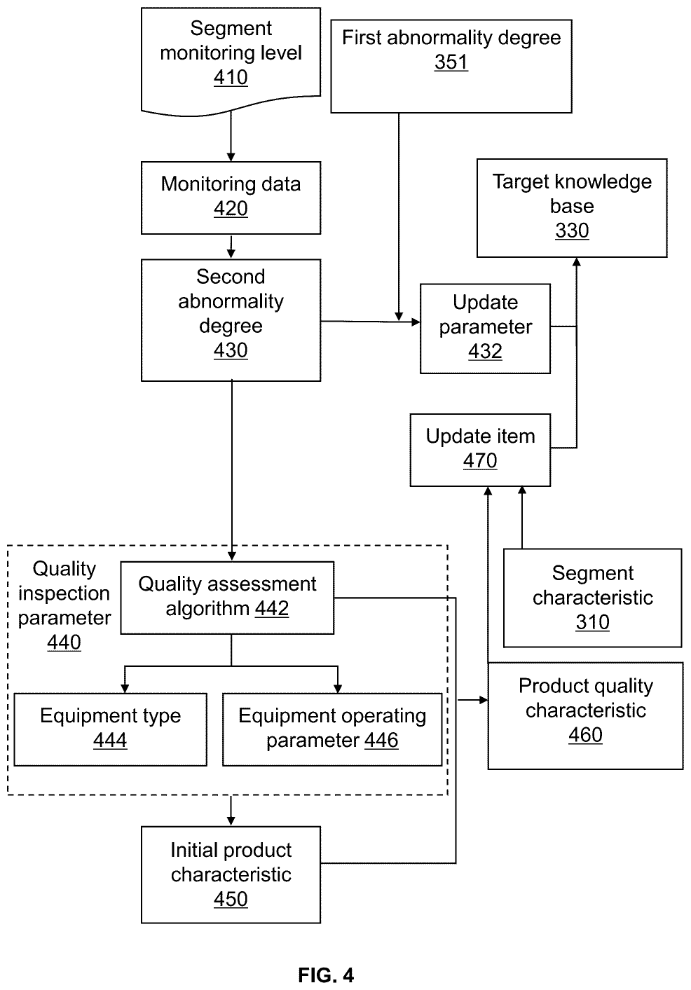

The quality inspection parameter is a relevant parameter required for quality inspection of the segment. For example, the quality inspection parameter may include an equipment type, an equipment operating parameter, etc., of the quality inspection device. For a more detailed description of the equipment type of the quality inspection device and the equipment operating parameter of the quality inspection device, please refer to FIG. 4 and the related descriptions thereof.

In some embodiments, the IIoT management platform may determine the quality inspection parameter in a variety of ways based on the segment monitoring level, and issue the quality inspection parameter to the quality inspection device of the IIoT perceptual control platform. For example, the IIoT management platform may obtain, based on a segment monitoring level, a corresponding quality inspection parameter by querying a first predetermined table.

The first predetermined table may be constructed by a technician based on historical data or prior knowledge, and contain a correspondence between segment monitoring levels and quality inspection parameters.

More descriptions of the determination of the quality inspection parameter may be found in FIG. 4 and its related descriptions.

In 224, obtaining a product quality characteristic of the segment by controlling the quality inspection device to perform a quality inspection on a product of the segment based on the quality inspection parameter.

The product quality characteristic refers to data obtained by testing the product of the segment. For example, the product quality characteristic may include product size data, image data, product quality data (e.g., the count of products, the count of abnormal products, etc.), or the like.

In some embodiments, the IIoT management platform may control the quality inspection device to perform the quality inspection on the product of the target segment based on the equipment type corresponding to the quality inspection device and the equipment operating parameter in the quality inspection parameter to obtain the product quality characteristic of the target segment.

In 225, updating the quality database by generating quality update data based on the segment characteristic and the product quality characteristic.

The quality update data refers to relevant data required to update the quality database. For example, the quality update data may include an update item needed to update the quality database, such as the segment characteristic of the target segment, the product quality characteristic of the target segment, etc.

In some embodiments, the IIoT management platform may generate the quality update data based on the segment characteristic and the product quality characteristic, and update the quality database in multiple ways. For example, the IIoT management platform may generate a new data record of the target segment based on the segment characteristic and the product quality characteristic of the target segment, and store the new data record in the quality database.

In some embodiments, the IIoT management platform may merge similar data records to organize the quality database, preventing insufficient database space caused by continuously storing new data. The similar data records refer to records on data of a same type whose difference does not exceed a corresponding difference threshold, which may be preset by a user. Data of the same type refers to data with identical field names.

In some embodiments of the present disclosure, by matching the segment characteristic of each segment of the current production line in the quality database, the segment criticality degree, the first abnormality degree, and the segment monitoring level are determined to determine an appropriate quality inspection parameter, which enables a more targeted quality inspection on the segment, better updates the quality database, and provides a more comprehensive data reference for optimizing the overall production process of the production line, thereby establishing an effective product quality evaluation system.

It should be noted that the foregoing descriptions of process 200 are intended to be exemplary and illustrative only and do not limit the scope of application of the present disclosure. For a person skilled in the art, various corrections and changes may be made to process 200 under the guidance of this disclosure. However, these corrections and changes remain within the scope of this disclosure.

FIG. 3 is an exemplary schematic diagram illustrating the determination of a first abnormality degree and a segment criticality degree according to some embodiments of the present disclosure.

In some embodiments, as shown in FIG. 3, an IIoT management platform may identify a target knowledge base 330 by searching in a quality database 320 based on a segment characteristic 310, and determining the first abnormality degree 351 and the segment criticality degree 352 based on the target knowledge base 330. More descriptions of the IIoT management platform may be found in FIG. 1 and the related descriptions thereof. More descriptions of the quality database and the segment characteristic may be found in FIG. 2 and the related descriptions thereof.

In some embodiments, the quality database 320 may include a plurality of knowledge bases. Each knowledge base has a same form as the quality database. However, a difference between the knowledge bases is that at least one of an amount of data included and historical data used for construction is different. For example, a knowledge base KA is constructed based on historical data from summer, while a knowledge base KB is constructed based on historical data from winter. As another example, the knowledge base KA is constructed based on historical data of process A and process B, while the knowledge base KB is constructed based on historical data of process C and process D.

The target knowledge base 330 refers to the knowledge base used to match historical segments.

In some embodiments, the IIoT management platform may retrieve, based on the segment characteristic of the target segment, a plurality of knowledge bases in the quality database to determine the target knowledge base. For example, the IIoT management platform may determine the target knowledge base based on the segment characteristic of the target segment through the following operations S1-S3:

In S1, the IIoT management platform may extract a portion of the segment characteristic as a to-be-matched feature, and use a portion of a historical segment characteristic in the knowledge base as a historical matching feature, wherein the portion of the historical segment characteristic corresponds to the to-be-matched feature. The IIoT management platform may construct a second feature vector based on the to-be-matched feature, construct a second reference vector based on the historical matching feature, and search the quality database based on the second feature vector. The IIoT management platform may return a count of matching second reference vectors (e.g., a count of vectors with a similarity greater than a similarity threshold) in each knowledge base. The to-be-matched feature refers to a feature in the segment characteristic used to match historical segments. For example, a similarity in part characteristics within segment characteristics may indicate a certain similarity in production processes, so a part name and a maximum part dimension in the part characteristic of the segment characteristic may be selected as the to-be-matched feature. It may be understood that each row of data in the knowledge base corresponds to a second reference vector.

In S2, the IIoT management platform may determine a matching degree for each knowledge base. The matching degree is a proportion of the count of matching second reference vectors to a data volume of the knowledge base. The data volume of the knowledge base may be a total count of rows in the knowledge base.

In S3, the IIoT management platform may determine a knowledge base with a highest matching degree as the target knowledge base.

In some embodiments, the segment characteristic may include at least one of a part characteristic and an assembly characteristic. More descriptions of the part characteristic and the assembly characteristic may be found in the related description of FIG. 2.

In some embodiments of the present disclosure, the IIoT management platform may determine a knowledge base scale level based on a machining accuracy of the part characteristic of the target segment and an assembly accuracy of the assembly characteristic of the target segment, and determine the target knowledge base based on the knowledge base scale level.

The knowledge base scale level refers to data that reflects a scale of the data volume of the knowledge base. The higher the knowledge base scale level of a knowledge base is, the larger the data volume contained in the knowledge base.

In some embodiments of the present disclosure, the IIoT management platform may determine the knowledge base scale level based on the machining accuracy of the part characteristics of the target segment and the assembly accuracy of the assembly characteristics of the target segment. For example, the knowledge base scale level may be positively correlated to the machining accuracy of the part characteristic and the assembly accuracy of the assembly characteristic. By way of example, the knowledge base scale level may be determined based on Equation (1):

$$R = {( {a}^{⋆} 1 + {b}^{⋆} z )}^{⋆} k , \qquad ( 1 )$$

In Equation (1), R denotes the knowledge base scale level, a and b denote weight coefficients of the machining accuracy and the assembly accuracy, respectively, with values ranging from 0 to 1, and the sum of a and b is 1. j denotes the machining accuracy of the part characteristic, z denotes the assembly accuracy of the assembly characteristic, and k denotes a maximum data volume in all knowledge bases in the quality database.

In some embodiments of the present disclosure, the IIoT management platform may determine the target knowledge base in multiple ways based on the knowledge base scale level. For example, the IIoT management platform may implement operations S1-S3 to determine the target knowledge base, replacing operations S3 with operations S3.1-S3.3:

In S3.1, the IIoT management platform may select one or more knowledge bases whose matching degree is greater than the matching threshold as one or more candidate knowledge bases. If there is only one candidate knowledge base, the subsequent operations may be skipped and the one knowledge base may be directly identified as the target knowledge base.

In S3.2, the IIoT management platform may determine the knowledge base scale level based on the machining accuracy of the part characteristic of the segment characteristic and the assembly accuracy of the assembly characteristic of the segment characteristic. More descriptions of the determination of the knowledge base scale level based on the machining accuracy of the part characteristic of the segment characteristic and the assembly accuracy of the assembly characteristic of the segment characteristic may be found in in the previous related descriptions.

In S3.3, the IIoT management platform may select, from the one or more candidate knowledge bases, a candidate knowledge base with a data volume closest to the knowledge base scale level as the target knowledge base.

In some embodiments of the present disclosure, by determining the knowledge base scale level based on the machining accuracy and the assembly accuracy of the target segment and thereby determining the target knowledge base, a target knowledge base that more closely matches the machining accuracy and assembly accuracy of the target segment can be selected, which facilitates the subsequent determination of parameters such as a more accurate first abnormality degree, a more accurate segment criticality degree, etc., for the target segment.

In some embodiments of the present disclosure, the IIoT management platform may determine the first abnormality degree and the segment criticality degree based on the segment characteristic through the target knowledge base. The manner of determining the first abnormality degree and the segment criticality degree based on the segment characteristic through the target knowledge base is similar to the manner of determining the first abnormality degree and the segment criticality degree based on the segment characteristic through the quality database, which may be found in FIG. 2 and the related descriptions thereof.

In some embodiments of the present disclosure, as shown in FIG. 3, the IIoT management platform may determine a production structure map 312 based on the segment characteristic 310 of one or more segments, and determine, based on the production structure map 312, the first abnormality degree 351 and the segment criticality degree 352 through a quality model 340 corresponding to the target knowledge base for the target segment.

The production structure map 312 is a map that reflects an overall production structure of a current production line.

In some embodiments of the present disclosure, the IIoT management platform may construct the production structure map based on the segment characteristic of the one or more segments. For example, nodes of the production structure map may correspond to segments of the current production line, a node feature of a node may include the segment characteristic of the segment corresponding to the node. Two nodes corresponding to segments with a sequential production relationship may be connected by an edge. An edge feature of an edge may include a direction of the edge, which points from a previous segment to a subsequent segment in the production line.

The quality model 340 is a model for determining the first abnormality degree and the segment criticality degree. In some embodiments of the present disclosure, the quality model may be a machine learning model. For example, the quality model may be a graph neural network (GNN) model, or the like. In some embodiments of the present disclosure, an input of the quality model may include the production structure map, and an output of the quality model may include the first abnormality degree and the segment criticality degree of one or more segments determined based on one or more nodes of the production structure map.

In some embodiments of the present disclosure, different knowledge bases correspond to different quality models. For example, training samples for the quality models of different knowledge bases are different. When training a quality model corresponding to a knowledge base, the training samples for training the quality model include historical data of the knowledge base. Therefore, different quality models may have different model parameters.

In some embodiments of the present disclosure, taking the training of a quality model corresponding to the target knowledge base as an example. The quality model corresponding to the target knowledge base may be acquired based on a large number of training samples with training labels.

The training samples may include sample production structure maps generated based on historical records. For example, the training sample may be generated from the segment characteristic of one or more sample segments of a production line in the target knowledge base, in a manner similar to the manner in which the production structure map is constructed. More descriptions of the construction of the production structure map may be found in the preceding related descriptions.

The training label of a sample production structure map may include a first abnormality degree and a segment criticality degree of each of one or more segments corresponding to the sample production structure map. The first abnormality degree in the training label is determined in a manner similar to the manner in which the first abnormality degree is determined. More descriptions of the determination of the first abnormality degree may be found in FIG. 2 and the related descriptions thereof.

In some embodiments of the present disclosure, the segment criticality degree of each sample segment in the training label may be determined based on a difference between a count of abnormal products in the sample segment and a count of substandard products in a previous segment of the sample segment. For example, the segment criticality degree of a sample segment may be positively correlated to the difference between the count of abnormal products in the sample segment and the count of substandard products in the previous segment.

In some embodiments of the present disclosure, the IIoT management platform may input a large number of sample production structure maps obtained from the target knowledge base into an initial quality model, construct training labels based on outputs of the initial quality model corresponding to the sample production structure maps, construct a loss function, and iteratively update the initial quality model based on the loss function. When the value of the loss function satisfies an iteration completion condition, the training is completed and a trained quality model is obtained. The iteration completion condition may include the loss function converging, a count of iterations reaching a threshold, or the like.

In some embodiments of the present disclosure, the IIoT management platform may input the production structure map into the quality model corresponding to the target knowledge base, and determine a first abnormality degree and a segment criticality degree corresponding to the target segment from the first abnormality degree(s) and the segment criticality degree(s) of the one or more segments output from the quality model.

According to some embodiments of the present disclosure, by constructing the production structure map, and then determining the first abnormality degree(s) and the segment criticality degree(s) of one or more segments through the quality model corresponding to the target knowledge base, the determined first abnormality degree and segment criticality degree of the target segment can be made more consistent with actual situations, so that a more accurate segment monitoring level and a more accurate quality inspection parameter can be determined subsequently.

In some embodiments, the output of the quality model may further include a segment monitoring level of each of the one or more segments.

In some embodiments, when the output of the quality model includes the segment monitoring level(s) of the one or more segments, the IIoT management platform may include the segment monitoring level(s) of the one or more segments corresponding to the sample production structure map in the training label. The segment monitoring level(s) of the one or more segments in the training label may be determined based on the first abnormality degree(s) and the segment criticality degree(s) of the one or more segments in the training label in a manner similar to the manner of determining the segment monitoring level based on the first abnormality degree and the segment criticality degree, as may be found in related descriptions of FIG. 2. The training process of the quality model when the output of the quality model includes the segment monitoring level(s) of the one or more segments is similar to the training process described in the relevant description of the previous section.

In some embodiments, the IIoT management platform may input the production structure map into the quality model corresponding to the target knowledge base, and determine, from the segment monitoring level(s) of the one or more segments outputted from the quality model, a segment monitoring level corresponding to the target segment.

According to some embodiments of the present disclosure, by including the segment monitoring level(s) of the one or more segments in the output of the quality model, the segment monitoring level can be determined more efficiently and accurately based on the quality model, so that a more appropriate quality inspection parameter can be subsequently determined.

Different knowledge bases may be constructed from different types of historical data, and in some embodiments of the present disclosure, by determining the target knowledge base based on the quality database, a knowledge base that is more suitable for the target segment can be obtained. Matching based on the target knowledge base to determine the first anomaly degree and the segment criticality degree of the target segment can enhance the reliability of the first anomaly degree and segment criticality of the target segment.

FIG. 4 is an exemplary schematic diagram illustrating the determination of a quality inspection parameter according to some embodiments of the present disclosure.

In some embodiments, as shown in FIG. 4, a quality inspection parameter 440 includes at least a quality assessment algorithm 442, an equipment type 444 of a quality inspection device, and an equipment operating parameter 446 of the quality inspection device. The IIoT management platform 130 may determine the quality assessment algorithm 442 based on a segment monitoring level 410, and determine the equipment type 444 and the equipment operating parameter 446 based on the quality assessment algorithm 442. The IIoT management platform 130 may control the quality inspection device to perform a quality inspection on a product of a segment based on the quality inspection parameter 440 to obtain an initial product characteristic 450 of the segment, and processing the initial product characteristic 450 based on the quality assessment algorithm 442 to obtain the product quality characteristic 460.

The quality assessment algorithm 442 is an algorithm for quantitatively assessing product characteristics. In some embodiments, the quality assessment algorithm may include a data collection type and a data collection granularity level. The data collection type refers to a type of data to be collected. The data collection granularity level reflects a level of detail of the collected data, e.g., the higher a data collection frequency and a data collection precision are, the higher the data collection granularity level is.

In some embodiments, the quality assessment algorithm may further include an algorithm type. The algorithm type refers to a type of an algorithm used to process the data, e.g., the algorithm type may include filtering out non-conforming products based on conditions.

In some embodiments, the algorithm type may include outlier removal and averaging, data fitting, or the like.

For example, for measuring a flatness of a part, the algorithm type may include using a probe to measure heights of multiple measurement points on a same plane, and the flatness of the part is determined by subtracting a minimum height from a maximum height. As another example, the algorithm type may include using a relatively complex data fitting technique to measure a flatness of an object, which may include the following operations:
(1) Collecting images of a surface of the object to be measured from multiple angles;
(2) Extracting feature points from each image and determining a fitted plane by perform plane fitting on the feature points in a same coordinate system, such as using a least squares method (LSM) or random sample consensus (RANSAC) for fitting.

(3) Calculating the flatness based on the fitted plane.

More descriptions of the initial product characteristic may be found in related descriptions below.

In some embodiments, the IIoT management platform may determine the quality assessment algorithm based on the segment monitoring level in multiple ways. For example, the IIoT management platform may determine an algorithmic level of the quality assessment algorithm based on the segment monitoring level, and different algorithmic levels may correspond to different data collection types.

By way of example, the algorithm level of the quality assessment algorithm may have a one-to-one correspondence with the segment monitoring level. For example, the algorithm level includes 10 levels and the segment monitoring level includes 10 levels. The quality assessment algorithm with a higher algorithmic level may involve more data collection types, a higher data collection granularity level, and more complex algorithm types. The quality assessment algorithm corresponding to each algorithm level may be preset by a user.

More descriptions of the segment monitoring level and the segment characteristic may be found in FIG. 2 and the related descriptions thereof.

In some embodiments of the present disclosure, the IIoT management platform may obtain monitoring data 420 based on the segment monitoring level 410; determine a second abnormality degree 430 of the segment based on the monitoring data 420; and determine the quality assessment algorithm 442 based on the second abnormality degree 430.

The monitoring data 420 refers to real-time monitoring data of the segment. For example, the monitoring data may include a production speed, an equipment operating status, dimensional data, image data, or the like.

In some embodiments of the present disclosure, the IIoT management platform may obtain the monitoring data based on the segment monitoring level. By way of example, the IIoT management platform may determine, based on the segment monitoring level, a monitoring data type and a monitoring data granularity level by querying a second predetermined table. Based on the monitoring data type and the monitoring data granularity level, the monitoring data may be obtained through a monitoring device and the quality inspection device of the IIoT perceptual control platform 150. For example, the production speed and the equipment operating status of the target segment may be obtained through the monitoring device, and the dimensional data and the image data may be obtained through the quality inspection device. The definitions of the monitoring data type and the monitoring data granularity level are similar to the definitions of data collection type and the data collection granularity level, and specific details may be found in the relevant descriptions above.

The second predetermined table may be constructed by a person skilled in the art based on experience, and the second predetermined table includes a correspondence between different segment monitoring levels and monitoring data types and monitoring data granularities. By way of example, a higher segment monitoring level corresponds to more monitoring data types and a higher monitoring data granularity level.

The second abnormality degree is an indicator of a degree of abnormality of the monitoring data of the segment.

In some embodiments of the present disclosure, the second abnormality degree may be positively correlated to a percentage of anomalous data in the monitoring data. When the monitoring device monitors that the value of any data type of a piece of the monitoring data is outside of a corresponding range of normal values, the piece of the monitoring data is determined as anomalous data, and the range of normal values may be predetermined by the technician. By way of example, the IIoT management platform may determine the second abnormality degree through Equation (2)

$$m = {c}^{⋆} n , \qquad ( 2 )$$

wherein m denotes the second abnormality degree, c is a conversion factor, and n denotes the percentage of anomalous data in the monitoring data. The conversion coefficient is a coefficient used to make the comparison between the first abnormality degree and the second abnormality degree more consistent with actual conditions, and may be set based on the actual conditions.

In some embodiments of the present disclosure, the IIoT management platform may determine the quality assessment algorithm based on the second abnormality degree in multiple ways. For example, the IIoT management platform may determine the quality assessment algorithm by querying a third predetermined table based on a range of values of the second abnormality degree. The third predetermined table is a table that maps different ranges of values of the second abnormality degree to different quality assessment algorithms. By way of example, the third predetermined table may be represented as follows: {second abnormality degree 1% to 20%, quality assessment algorithm A; second abnormality degree 21% to 40%, quality assessment algorithm B; . . . }. The higher the second abnormality degree is, the more complex the corresponding quality assessment algorithm may be set. The more complex of the quality assessment algorithm may be reflected as more data collection types, a higher data collection granularity level, and a higher algorithm level.

In some embodiments of the present disclosure, the quality assessment algorithm is determined based on the segment monitoring level, which makes the assessment process more targeted and precise, which helps to quickly identify critical segments in the production line, thereby improving the efficiency of product quality assessment.

In some embodiments, the IIoT management platform may adjust the quality assessment algorithm for one or more segments based on a resource allocation of a server to determine a target assessment algorithm.

As different segments correspond to quality assessment algorithms of different levels of complexity, the server resources invoked when using the quality assessment algorithms of different levels of complexity are different. By way of example, assuming there are 20 servers that are used to support the product quality assessment for each segment. If a production line has 10 segments, and all the 10 segments use a most complex quality assessment algorithm, a load on hardware resources may be excessive, which may lead to resource contention and affecting quality assessment. Therefore, when determining quality assessment algorithm algorithms for multiple segments, the allocation of server resources may be combined with a load capacity of the server.

More descriptions of the server may be found in FIG. 1 and the related descriptions thereof.

The target assessment algorithm is an ultimately determined algorithm, which includes the quality assessment algorithms corresponding to each of the one or more segments.

In some embodiments, the IIoT management platform may assess the resource allocation of the server in multiple ways. For example, the IIoT management platform may call a resource usage of the server via an IIoT service platform. In response to the resource usage not exceeding a usage threshold, the IIoT management platform may determine that the resource allocation of the server is sufficient. The usage threshold may be preset by a technician based on experience. More descriptions of the IIoT service platform may be found in FIG. 1 and the related descriptions thereof.

In some embodiments, the IIoT management platform may adjust the quality assessment algorithm for the one or more segments based on the allocation of resources of the server, thereby determining the target assessment algorithm. For example, the IIoT management platform may preset a segment priority for each of the one or more segments of the current production line, and the smaller the value of the segment priority is, the more important the segment corresponding to the segment priority is. In response to the resource allocation of the server being insufficient, the quality evaluation algorithm levels are reduced in a descending order of the segment priorities. Each time the quality evaluation algorithm level of a segment is reduced, the resource allocation of the server is reassessed until the server resources are sufficiently allocated. The adjustment of the quality assessment algorithm is then stopped, and the final quality assessment algorithm for the one or more segments are determined as the target evaluation algorithm.

The segment priority may be set by a person skilled in the art based on the current production line. For example, a segment in a rough processing stage may have a relatively large segment priority value. As another example, a segment in a surface treatment stage may also have a relatively large segment priority value.

More descriptions of the algorithm level of the quality assessment algorithm may be found in the previous related descriptions.

In some embodiments of the present disclosure, the quality assessment algorithm is flexibly adjusted by considering the resource allocation of the server, ensuring that the assessment process can make full use of server resources, avoiding resource waste or insufficiency, thereby improving evaluation efficiency.

The equipment type refers to a category of the quality inspection device.

The equipment operating parameter 446 refers to a parameter followed by the quality inspection device during operation. For example, the equipment operating parameter may include a data collection frequency, or the like.

In some embodiments of the present disclosure, the IIoT management platform may determine, based on the quality assessment algorithm, the equipment type and the equipment operating parameter of the quality inspection device in multiple ways. For example, the IIoT management platform may determine, based on the data collection type in the quality assessment algorithm, the equipment type capable of collecting data of the corresponding data collection type; and determine the data collection frequency of the corresponding quality inspection device based on the data collection granularity level of the collected data.

The initial product characteristic 450 refers to raw, unprocessed data collected by the quality inspection device. In some embodiments of the present disclosure, the IIoT management platform may, based on the quality inspection parameters, perform a quality inspection on a product of the segment using the quality inspection device of the IIoT perceptual control platform to obtain the initial product characteristic.

In some embodiments of the present disclosure, the IIoT management platform may process the initial product characteristic in multiple ways to obtain the product quality characteristic. For example, the IIoT management platform may process the initial product quality characteristic based on the algorithm type of the quality assessment algorithm, and determine the processed data as the product quality characteristic. The algorithm type may include a data cleaning algorithm for removing duplicate data.

More descriptions of the product quality characteristic may be found in FIG. 2 and its associated description.

In some embodiments of the present disclosure, by comprehensively considering the segment monitoring level, the quality assessment algorithm, the equipment type of the quality inspection device, and the equipment operating parameter of the quality inspection device, high flexibility and scalability can be achieved in assessing product quality. The quality inspection parameter and the quality assessment algorithm can be adjusted flexibly according to the needs of different production segments and products, adapting to the product quality assessment needs in different scenarios, realizing the precise determination of the quality inspection parameter, and improving the accuracy and reliability of product quality inspection.

In some embodiments of the present disclosure, the quality update data includes an update parameter and an update item. In some embodiments of the present disclosure, as shown in FIG. 4, the IIoT management platform may determine an update parameter 432 based on a difference characteristic between the first abnormality degree 351 and a second abnormality degree 430; determine an update item 470 based on the segment characteristic 310 and the product quality characteristic 460; and update the update item 470 of the segment to the target knowledge base 330 based on the update parameter 432.

The difference characteristic between the first abnormality degree and the second abnormality degree refers to a difference between the first abnormality degree and the second abnormality degree.

The update parameter 432 is a parameter used when an update is performed on the target database. For example, the update parameter may include an update frequency, an update detail level, or the like. In some embodiments of the present disclosure, the update parameter may be positively correlated to the difference characteristic, i.e., the greater the difference characteristic is, the higher the update frequency is and the more detailed the update detail level is. The update detail level may include abbreviated, general, relatively detailed, detailed, etc. The more detailed the update detail level is, the larger amount of data is updated at one time.

The update item 470 refers to a segment item that needs to be updated to the target knowledge base. For example, the update item may include at least one of the segment characteristic and the product quality characteristic.

In some embodiments of the present disclosure, the IIoT management platform may determine the update item of the target segment in a variety of ways based on the segment characteristic and the product quality characteristic, and update the update item to the target knowledge base based on the update parameter. For example, the IIoT management platform may determine a similarity threshold via a fourth predetermined table based on the update detail level in the update parameter, and determine data that needs to be merged based on the segment characteristic, the product quality characteristic, and the similarity threshold, thereby determining the update item of the target segment. Finally, the IIoT management platform may update the update item to the target knowledge base based on the update frequency in the update parameter. The fourth predetermined table may be constructed by a person skilled in the art based on experience, and may include a correspondence between update detail levels and similarity thresholds. The higher an update detail level is, the higher the similarity threshold corresponding to the update detail level is.

By way of example, the IIoT management platform determines the similarity threshold through the fourth predetermined table. Based on the segment characteristic and the product quality characteristic of the target segment obtained in a current update operation, the IIoT management platform constructs a vector and performs matching in the target knowledge base. Segment characteristics and product quality characteristics with a similarity exceeding the similarity threshold are averaged with the data obtained in the current update operation and merged into a new piece of data as an update item for the target segment. Based on the update frequency, the update item is updated to the target knowledge base. As an example, when the update detail level is detailed, the similarity threshold is the highest, and it may not be possible to match segment characteristics and product quality characteristics with a similarity exceeding the similarity threshold. In this case, the industrial Internet of Things management platform may use all the data obtained in the current update operation as the update item. The similarity can be calculated based on a cosine distance, a Euclidean distance, or the like.

In some embodiments of the present disclosure, by determining the update parameter based on the difference characteristic between the first abnormality degree and the second abnormality degree, the update process becomes more scientific and can accurately capture target segments with special conditions. This enables targeted updates to the target knowledge base or the quality database, avoiding ineffective or redundant update operations.

Some embodiments of the present disclosure further provide a non-transitory computer-readable storage medium that stores computer instructions, and when a computer reads the computer instructions in the storage medium, the computer implements the method for assessing product quality.

The basic concepts are described above. Obviously, for those skilled in the art, the above detailed disclosure is only an example, and does not constitute a limitation to the present disclosure. Although not expressly stated here, those skilled in the art may make various modifications, improvements, and corrections to the present disclosure. Such modifications, improvements and corrections are suggested in present disclosure, so such modifications, improvements, and corrections still belong to the spirit and scope of the exemplary embodiments of the present disclosure.

Meanwhile, the present disclosure uses specific words to describe the embodiments of the present disclosure. For example, “one embodiment,” “an embodiment,” and/or “some embodiments” refer to a certain feature, structure or characteristic related to at least one embodiment of the present disclosure. Therefore, it should be emphasized and noted that references to “one embodiment” or “an embodiment” or “an alternative embodiment” two or more times in different places in the present disclosure do not necessarily refer to the same embodiment. In addition, certain features, structures or characteristics in one or more embodiments of the present disclosure may be properly combined.

In addition, unless clearly stated in the claims, the sequence of processing elements and sequences described in the present disclosure, the use of counts and letters, or the use of other names are not used to limit the sequence of processes and methods in the present disclosure. While the foregoing disclosure has discussed by way of various examples some embodiments of the invention that are presently believed to be useful, it should be understood that such detail is for illustrative purposes only and that the appended claims are not limited to the disclosed embodiments, but rather, the claims are intended to cover all modifications and equivalent combinations that fall within the spirit and scope of the embodiments of the present disclosure. For example, although the implementation of various components described above may be embodied in a hardware device, it may also be implemented as a software only solution, e.g., an installation on an existing server or mobile device.

In the same way, it should be noted that in order to simplify the expression disclosed in this disclosure and help the understanding of one or more embodiments of the invention, in the foregoing description of the embodiments of the present disclosure, sometimes multiple features are combined into one embodiment, drawings or descriptions thereof. This manner of disclosure does not, however, imply that the subject matters of the disclosure requires more features than are recited in the claims. Rather, claimed subject matters may lie in less than all features of a single foregoing disclosed embodiment.

In some embodiments, numbers describing the quantity of components and attributes are used. It should be understood that such counts used in the description of the embodiments use the modifiers “about,” “approximately,” or “substantially” in some examples. Unless otherwise stated, “about”, “approximately” or “substantially” indicates that the stated figure allows for a variation of +20%. Accordingly, in some embodiments, the numerical parameters used in the disclosure and claims are approximations that may vary depending upon the desired characteristics of individual embodiments. In some embodiments, numerical parameters should consider the specified significant digits and adopt the general digit retention method. Although the numerical ranges and parameters used in some embodiments of the present disclosure to confirm the breadth of the range are approximations, in specific embodiments, such numerical values are set as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for assessing product quality based on Industrial Internet of Things (IIoT), the method being executed by an IIoT management platform, and the method comprising:
obtaining one or more segments of a current production line based on an IIoT perceptual control platform;
for each segment of the one or more segments:
determining, based on a segment characteristic of the segment, a first abnormality degree and a segment criticality degree of the segment through a quality database;
determining a segment monitoring level based on the segment criticality degree and the first abnormality degree;
determining a quality inspection parameter based on the segment monitoring level and issuing the quality inspection parameter to a quality inspection device of the IIoT perceptual control platform;
obtaining a product quality characteristic of the segment by controlling the quality inspection device to perform a quality inspection on a product of the segment based on the quality inspection parameter; and
updating the quality database by generating quality update data based on the segment characteristic and the product quality characteristic.

2. The method of claim 1, wherein the quality database includes a plurality of knowledge bases, and the determining, based on a segment characteristic of the segment, a first abnormality degree and a segment criticality degree of the segment through a quality database includes:
identifying a target knowledge base by searching in the quality database based on the segment characteristic; and
determining the first abnormality degree and the segment criticality degree based on the target knowledge base.

3. The method of claim 2, wherein the segment characteristic includes at least one of a part characteristic and an assembly characteristic, and the identifying a target knowledge base by searching in the quality database based on the segment characteristic includes:
determining a knowledge base scale level based on a machining accuracy of the part characteristic and an assembly accuracy of the assembly characteristic; and
determining the target knowledge base based on the knowledge base scale level.

4. The method of claim 2, wherein the determining the first abnormality degree and the segment criticality degree based on the target knowledge base includes:
determining a production structure map based on the segment characteristic of the one or more segments; and
determining, based on the production structure map, the first abnormality degree and the segment criticality degree through a quality model corresponding to the target knowledge base, the quality model being a machine learning model.

5. The method of claim 4, wherein an output of the quality model includes the segment monitoring level of the segment.

6. The method of claim 1, wherein the quality inspection parameter includes at least a quality assessment algorithm, an equipment type of the quality inspection device, and an equipment operating parameter of the quality inspection device; and the determining a quality inspection parameter based on the segment monitoring level includes:
determining the quality assessment algorithm based on the segment monitoring level;
determining the equipment type and the equipment operating parameter based on the quality assessment algorithm; and
the obtaining a product quality characteristic of the segment by controlling the quality inspection device to perform quality inspection on a product of the segment based on the quality inspection parameter includes:
obtain an initial product characteristic of the segment by controlling the quality inspection device to perform the quality inspection on the product of the segment based on the quality inspection parameter; and
processing the initial product characteristic based on the quality assessment algorithm to obtain the product quality characteristic.

7. The method of claim 6, wherein the determining the quality assessment algorithm based on the segment monitoring level includes:
obtaining monitoring data based on the segment monitoring level;
determining a second abnormality degree of the segment based on the monitoring data; and
determining the quality assessment algorithm based on the second abnormality degree.

8. The method of claim 7, wherein the quality update data includes an update parameter and an update item; and the updating the quality database by generating quality update data based on the segment characteristic and the product quality characteristic includes:
determining the update parameter based on a difference characteristic between the first abnormality degree and the second abnormality degree;
determining the update item based on the segment characteristic and the product quality characteristic; and
updating the update item of the segment to the target knowledge base based on the update parameter.

9. The method of claim 7, wherein the method further comprises:
determining a target assessment algorithm by adjusting the quality assessment algorithm for the one or more segments based on a resource allocation of a server.

10. A system for assessing product quality based on Industrial Internet of Things (IIoT), wherein the system comprises an IIoT user platform, an IIoT service platform, an IIoT management platform, an IIoT sensor network platform, and an IIoT perceptual control platform; the IIoT management platform is configured to:
obtain one or more segments of a current production line based on the IIoT perceptual control platform;
for each segment of the one or more segments:
determine, based on a segment characteristic of the segment, a first abnormality degree and a segment criticality degree of the segment through a quality database;
determine a segment monitoring level based on the segment criticality degree and the first abnormality degree;
determine a quality inspection parameter based on the segment monitoring level and issue the quality inspection parameter to a quality inspection device of the IIoT perceptual control platform;
obtain a product quality characteristic of the segment by controlling the quality inspection device to perform a quality inspection on a product of the segment based on the quality inspection parameter; and
update the quality database by generating quality update data based on the segment characteristic and the product quality characteristic.

11. The system of claim 10, wherein the quality database includes a plurality of knowledge bases, and the IIoT management platform is further configured to:
identify a target knowledge base by searching in the quality database based on the segment characteristic; and
determine the first abnormality degree and the segment criticality degree based on the target knowledge base.

12. The system of claim 11, wherein the segment characteristic includes at least one of a part characteristic and an assembly characteristic, and the IIoT management platform is further configured to:
determine a knowledge base scale level based on a machining accuracy of the part characteristic and an assembly accuracy of the assembly characteristic; and
determine the target knowledge base based on the knowledge base scale level.

13. The system of claim 11, wherein the IIoT management platform is further configured to:
determine a production structure map based on the segment characteristic of the one or more segments; and
determine, based on the production structure map, the first abnormality degree and the segment criticality degree through a quality model corresponding to the target knowledge base, the quality model being a machine learning model.

14. The system of claim 13, wherein an output of the quality model includes the segment monitoring level of the segment.

15. The system of claim 10, wherein the quality inspection parameter includes at least a quality assessment algorithm, an equipment type of the quality inspection device, and an equipment operating parameter of the quality inspection device; and the IIoT management platform is further configured to:
determine the quality assessment algorithm based on the segment monitoring level;
determine the equipment type and the equipment operating parameter based on the quality assessment algorithm;
obtain an initial product characteristic of the segment by controlling the quality inspection device to perform the quality inspection on the product of the segment based on the quality inspection parameter; and
process the initial product characteristic based on the quality assessment algorithm to obtain the product quality characteristic.

16. The system of claim 15, wherein the IIoT management platform is further configured to:
obtain monitoring data based on the segment monitoring level;
determine a second abnormality degree of the segment based on the monitoring data; and
determine the quality assessment algorithm based on the second abnormality degree.

17. The system of claim 16, wherein the quality update data includes an update parameter and an update item; and the IIoT management platform is further configured to:
determine the update parameter based on a difference characteristic between the first abnormality degree and the second abnormality degree;
determine the update item based on the segment characteristic and the product quality characteristic; and
update the update item of the segment to the target knowledge base based on the update parameter.

18. The system of claim 16, wherein the IIoT management platform is further configured to:
determine a target assessment algorithm by adjusting the quality assessment algorithm for the one or more segments based on a resource allocation of a server.

19. A non-transitory computer-readable storage medium storing computer instructions, wherein when reading the computer instructions in the storage medium, a computer implements a method for assessing product quality based on Industrial Internet of Things (IIoT), the method being executed by an IIoT management platform, and the method comprising:
obtaining one or more segments of a current production line based on an IIoT perceptual control platform;
for each segment of the one or more segments:
determining, based on a segment characteristic of the segment, a first abnormality degree and a segment criticality degree of the segment through a quality database;
determining a segment monitoring level based on the segment criticality degree and the first abnormality degree;
determining a quality inspection parameter based on the segment monitoring level and issuing the quality inspection parameter to a quality inspection device of the IIoT perceptual control platform;
obtaining a product quality characteristic of the segment by controlling the quality inspection device to perform a quality inspection on a product of the segment based on the quality inspection parameter; and
updating the quality database by generating quality update data based on the segment characteristic and the product quality characteristic.
